(19) United States
(12) Patent Application Publication
(10) Pub. No.: US 2008/0216526 A1
(43) Pub. Date: Sep. 11, 2008

(54) EASY-TO-INSTALL DOOR LOCK STRUCTURE

(75) Inventor: Joo Seok JEONG, Daegu (KR)

Correspondence Address: LOWE HAUPTMAN HAM & BERNER, LLP, 1700 DIAGONAL ROAD, SUITE 300, ALEXANDRIA, VA, 22314, US

(73) Assignee: SEWANG TECH CO., LTD, Daegu (KR)

(21) Appl. No.: 12/044,097

(22) Filed: Mar. 7, 2008

(30) Foreign Application Priority Data
Mar. 8, 2007 (KR) 2007-0023147

(51) Int. Cl. E05B 65/06

(52) U.S. Cl. 70/101

(57) ABSTRACT

The present invention relates to a door lock structure including: an inner fixing plate having a protruding ring adapted to rotatably receive one end of the inner lever; an inner mounting plate adapted to abut against one surface of the inner fixing plate; an outer fixing plate having a center hole adapted to rotatably receive one end of the outer lever and a plurality of protruding portions extending circumferentially from the center hole; an outer mounting plate adapted to abut against one side of the outer fixing plate and having a plurality of through-holes formed along the circumferential direction thereof; and elastic means adapted to provide a given elastic force so as to allow the inner lever and the outer lever to be returned to their original positions.

### BACKGROUND OF THE INVENTION

1. Field of the Invention

The present invention relates to a door lock, and more particularly, to a door lock structure that can be installed easily and improved in durability, while being used in both a steel door and a wood door.

2. Background of the Related Art

The sizes and positions of the coupling hole and the auxiliary holes formed on a steel or wood door are generally standardized according to American National Standard, wherein in case of the steel door, any one of a plurality of auxiliary holes formed at equal angles along the outer periphery of the coupling hole may be selectively determined.

FIG. 1 is an exploded perspective view showing main parts of a conventional door lock, and FIG.2 is an exploded perspective view showing main parts of another conventional door lock.

The conventional door lock, as shown in FIG. 1, which is disclosed in Korean Utility Model Registration No. 0383139 entitled ‘a coupling structure of a door lock’, includes an inner fixing plate 14, an inner mounting plate 15, an outer fixing plate 16, a pair of fixing bars 17 and an outer fixing plate 18 that are provided at the inside of covers 21 each adapted to cover an inner lever 11 and an outer lever 12 mounted at the inside and outside thereof. The fixing bars 17 and the outer fixing plate 18 are provided appropriately in consideration of the positions of the auxiliary holes of the door made by other manufacturers, but if the coupling structure of the door lock is to be mounted on the coupling hole of the steel door having the auxiliary holes formed at equal angles of 45° along the coupling hole, the parts of the coupling structure of the door lock should be all disassembled from the door, which causes inconvenience.

Another conventional door lock, as shown in FIG. 2, which is disclosed in Korean Patent No. 0396178 entitled ‘a lever door lock’, features that it can be effectively mounted in case where the door has a relatively thin or thick thickness. In the conventional door lock structure, the parts like a torsion spring 23, an upper holder 24 and a lower holder 25 are mounted at the inside of an adjusting screw pipe 22 to prevent the inner lever 11 and the outer lever 12 from falling down, and the female screw of the cover 21 is screw-coupled to a screw portion formed along the outer periphery of the adjusting screw pipe 22, such that the cover 21 can be easily adjusted in accordance with the variations of the thickness of the door, thereby enabling the door lock structure to be efficiently applied to a variety of thicknesses of the door, even without having any disassembling process of the outer lever 12. On the contrary, the screw-coupling is likely to be loosened or unfastened, and if a predetermined period of time elapses, the gap between the coupled adjusting screw pipe 22 and the cover 21 becomes large, thereby causing unpleasant noises or rendering the adjusting screw pipe 22 to escape from the cover 21.

### SUMMARY OF THE INVENTION

Accordingly, the present invention has been made in view of the above-mentioned problems occurring in the prior art, and it is an object of the present invention to provide a door lock structure that can be installed easily and improved in durability, while being used in both a steel door and a wood door.

To accomplish the above object, according to the present invention, there is provided a door lock structure adapted to pivotally open a door by means of the coupling of an inner lever and an outer lever mounted at the inside and outside of the door, the door lock structure including: an inner fixing plate having a protruding ring adapted to rotatably receive one end of the inner lever; an inner mounting plate adapted to abut against one surface of the inner fixing plate and having a plurality of protruding beads formed along the outer peripheral surface thereof; an outer fixing plate having a center hole adapted to rotatably receive one end of the outer lever and a plurality of protruding portions extending circumferentially from the center hole so as to determine the positions of a pair of fixing bars to be fixed thereon in accordance with the positions of holes formed on the door; an outer mounting plate adapted to abut against one side of the outer fixing plate and having a plurality of through-holes formed along the circumferential direction thereof; and elastic means adapted to provide a given elastic force so as to allow the inner lever and the outer lever to be returned to their original positions.

According to the present invention, preferably, each of the inner fixing plate and the outer fixing plate has a plurality of protruding pieces formed thereon so as to prevent the rotation when fixed on a wood door, thereby enabling the mounting to be easy irrespective of the thickness of the wood door.

According to the present invention, preferably, the elastic means includes a cylindrical outer adjusting pipe having a spiral portion formed along the outer periphery thereof, a cylindrical inner adjusting pipe having a flat portion formed along the outer periphery thereof, an upper holder having a finishing piece formed on one surface thereof, and a lower holder adapted to support a torsion spring together with the upper holder, thereby enabling the outer fixing plate to be rotated.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view showing main parts of a conventional door lock;

FIG. 2 is an exploded perspective view showing main parts of another conventional door lock;

FIG. 3 is an exploded perspective view showing main parts of a door lock structure according to the present invention;

FIG. 4 is a perspective view showing the assembled state of the door lock structure according to the present invention;

FIG. 5 is a sectional view showing the main parts of the door lock structure of FIG. 4 at a state where the door lock structure is installed on a steel door;

FIG. 6 is a top view showing the assembled state changed by means of an outer fixing plate in the door lock structure according to the present invention; and

FIG. 7 is a sectional view showing the main parts of the door lock structure according to the present invention at a state where the door lock structure is installed on a wood door.

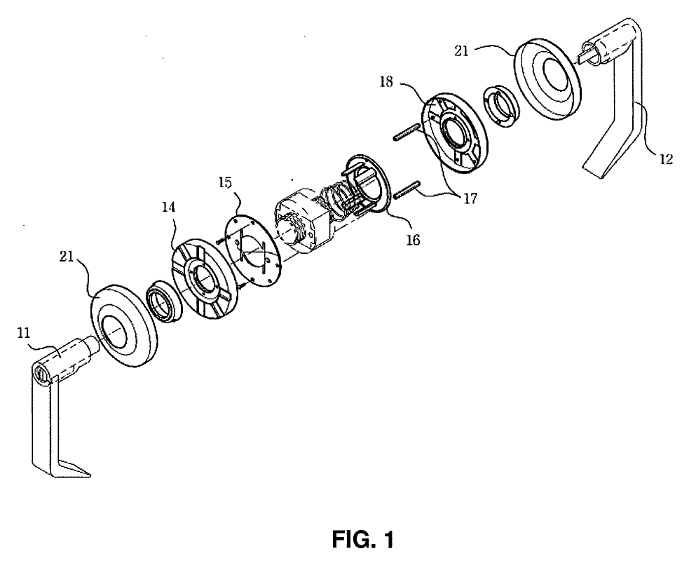

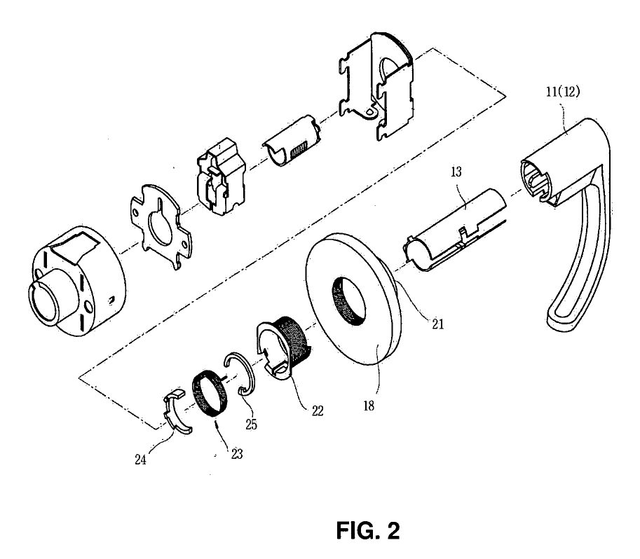

### DETAILED DESCRIPTION OF THE PREFERRED EMBODIMENT

Hereinafter, an explanation on a door lock structure according to a preferred embodiment of the present invention will be given with reference to the attached drawings.

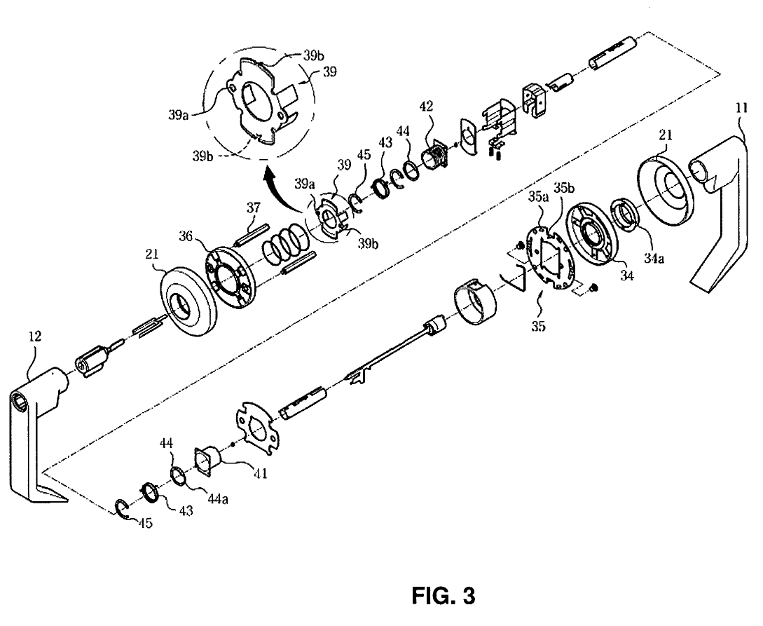

FIG. 3 is an exploded perspective view showing main parts of a door lock structure according to the present invention.

The present invention relates to a door lock structure adapted to pivotally open a door by means of the connection of an inner lever and an outer lever at the inside and outside thereof. In more details, the parts that will not be explained in the description of the present invention are described in the above-mentioned prior arts disclosed in Korean Utility Model Registration No. 0383139 entitled ‘a coupling structure of a door lock’ and Korean Patent No. 0396178 entitled ‘a lever door lock’. For example, the parts include a lock device, a spindle, a retractor outer fixing plate and a key assembly as the indoor side parts relative to the inner lever 11 and as the outdoor side parts relative to the outer lever 12.

According to the present invention, the door lock structure includes an inner fixing plate 34 having a protruding ring 34a adapted to rotatably receive one end of the inner lever 11. The protruding ring 34a is cylindrically molded integrally with the inner fixing plate 34. The formation of the protruding ring 34a allows the insertion depth of the inner lever 11 and the outer lever 12 to be increased, with a result that the generation of a gap during operation is suppressed to reduce the noise generation and improve the durability.

According to the present invention, further, the door lock structure includes an inner mounting plate 35 adapted to abut against one surface of the inner fixing plate 34 and having a plurality of protruding beads 35a formed along the outer periphery thereof. The protruding beads 35a are formed at symmetrical positions along the circumference of the inner mounting plate 35, thereby causing a relative sliding movement in a given range together with the inner fixing plate 34 at the time of installing the inner lever 11.

According to the present invention, further, an outer fixing plate 36 having a pair of fixing bars 37 is provided to rotatably receive one end of the outer lever 12. The outer fixing plate 36 is housed at the inside of the cover 21 and simultaneously rotatably receives one end of the outer lever 12. The pair of fixing bars 37 are fixed to the opposing two positions of the outer fixing plate 36. In the same manner as the conventional practice, the fixing bars 37 serve to prevent the arbitrary rotation of the outer fixing plate 36 at the time of fixing the outer fixing plate 36 to the steel door, each of the fixing bars 37 having a male screw formed at one end thereof and a female screw formed at the other end thereof.

According to the present invention, further, an outer mounting plate 39 having six through-holes 39a formed along the circumferential direction thereof is adapted to abut against one side of the outer fixing plate 36. The outer mounting plate 39 has the six through-holes 39a formed along the circumferential direction thereof and abuts against one side of the outer fixing plate 36, thereby allowing a relative movement with the outer fixing plate 36 within a range of a given angle.

According to the present invention, further, the door lock structure has elastic means adapted to provide a given elastic force so as to allow the inner lever 11 and the outer lever 12 to be returned to their original positions. The elastic means includes a cylindrical outer adjusting pipe 42 having a screw portion formed along the outer periphery thereof, a cylindrical inner adjusting pipe 41 having a flat portion formed along the outer periphery thereof, an upper holder 44 having a finishing piece 44a formed on one surface thereof; and a lower holder 45 adapted to support a torsion spring 43 together with the upper holder 44.

In the conventional practice, the upper holder 44 is partially opened, but in the present invention, it has the finishing piece 44a extended from one side thereof, thereby improving the stability of the operation. The upper holder 44 and the lower holder 45 serve to support the torsion spring 43, with a result that the inner lever 11 and the outer lever 12 are returned to their original positions after rotated.

At this time, each of the inner fixing plate 34, the outer fixing plate 36, the inner mounting plate 35 and the outer mounting plate 39 has the six through-holes formed to the corresponding positions to the positions of the auxiliary holes formed on a door specified according to American National Standard. Thus, even though the auxiliary holes are formed at any positions on the door under the standard, the outer fixing plate 36 is rotated to change the positions of the fixing bars 37 coupled thereto, thereby enabling the door lock structure to be easily installed on the door.

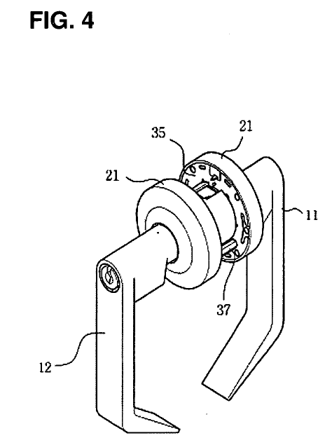

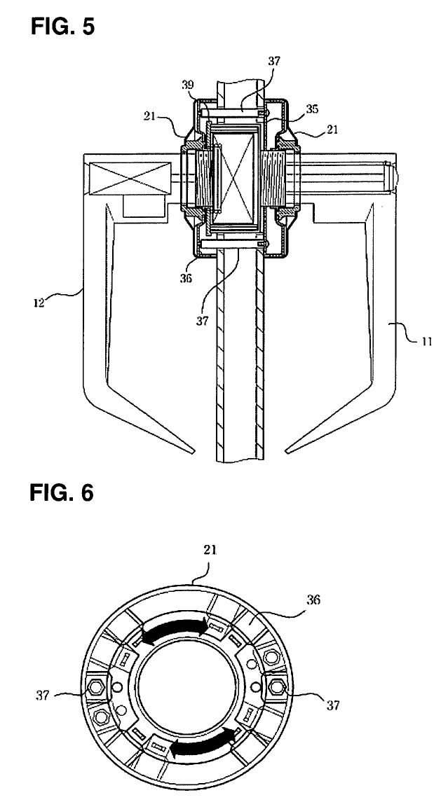

FIG. 4 is a perspective view showing the assembled state of the door lock structure according to the present invention, FIG. 5 is a sectional view showing the main parts of the door lock structure of FIG. 4 at a state where the door lock structure is installed on a steel door, and FIG. 6 is a top view showing the assembled state changed by means of the outer fixing plate in FIG. 5 in the door lock structure according to the present invention.

As shown in FIGS. 4 and 5, each of the pair of fixing bars 37 is formed of a square bar having a length longer than the thickness of the door at which the door lock is mounted, and it has the male and female screw parts formed at the both ends thereof, such that as they are coupled to the inner fixing plate 34 and the outer fixing plate 36, they are solidly fitted to the auxiliary holes formed on the door at the time of installing the door lock structure. If the positions of the fixing bars 37 are to be changed, the outer fixing plate 36 and the outer mounting plate 39 can be rotated relatively to each other as shown in FIG. 6, without any complete separation of the inner lever 11 and the outer lever 12 from the door, thereby making it convenient to change the positions of the fixing bars 37. This is possible because the inner lever 11, the outer lever 12 and the main parts connected to them are separable mechanically from one another.

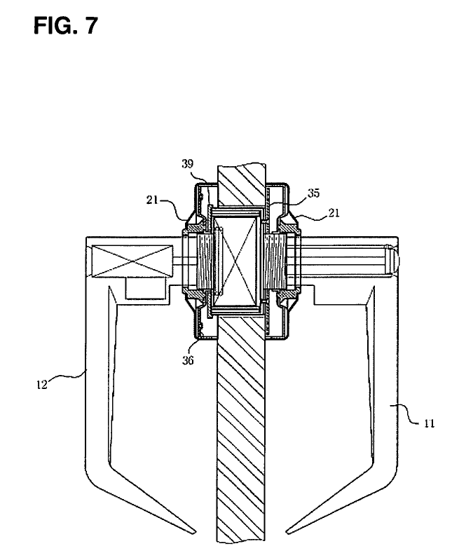

FIG. 7 is a sectional view showing the main parts of the door lock structure according to the present invention at a state where the door lock structure is installed on a wood door.

According to the present invention, the inner mounting plate 35 and the outer mounting plate 39 have respective protruding pieces 35b and 39b adapted to prevent their rotation at the time of being fixed to the wood door. As shown in FIG. 3, the inner mounting plate 35 has the protruding pieces 35b having a triangular sectional shape bent vertically from the upper and lower grooves thereof, and the outer mounting plate 39 has the protruding pieces 39b having a triangular sectional shape bent vertically from the protruding portions to the left and right sides thereof.

In case where the door lock structure according to the present invention is installed on the steel door, the fixing bars 37 are mounted, and on the contrary, in case where the door lock structure is installed on the wood door, the fixing bars 37 are removed and the inner mounting plate 35 and the outer mounting plate 39 abut against the inside and outside of the wood door, while the respective protruding pieces 35b and 39b are being brought into close contact with the wood door. Of course, the outer fixing plate 36 is rotated and mounted in accordance with the thickness of the wood door, without any separation of the inner lever 11 and the outer lever 12 from the wood door, and in this case, the functions of the protruding pieces 35b and 39b are still exerted.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

As described above, there is provided a door lock structure that can be installed easily and improved in durability, while being used in both a steel door and a wood door.

What is claimed is:

1. A door lock structure adapted to pivotally open a door by means of the coupling of an inner lever and an outer lever mounted at the inside and outside of the door, the door lock structure comprising:
an inner fixing plate having a protruding ring adapted to rotatably receive one end of the inner lever;
an inner mounting plate adapted to abut against one surface of the inner fixing plate and having a plurality of protruding beads formed along the outer periphery thereof;
an outer fixing plate having a center hole adapted to rotatably receive one end of the outer lever and a plurality of protruding portions extending circumferentially from the center hole so as to determine the positions of a pair of fixing bars to be fixed thereon in accordance with the positions of holes formed on the door;
an outer mounting plate adapted to abut against one side of the outer fixing plate and having a plurality of through-holes formed along the circumferential direction thereof; and
elastic means adapted to provide a given elastic force so as to allow the inner lever and the outer lever to be returned to their original positions.

2. The easy-to-install door lock structure according to claim 1, wherein each of the inner fixing plate and the outer fixing plate has a plurality of protruding pieces formed thereon so as to prevent the rotation when fixed on a wood door, thereby enabling the mounting to be easy irrespective of the thickness of the wood door.

3. The easy-to-install door lock structure according to claim 1, wherein the elastic means includes a cylindrical outer adjusting pipe having a screw portion formed along the outer periphery thereof, a cylindrical inner adjusting pipe having a flat portion formed along the outer periphery thereof, an upper holder having a finishing piece formed on one surface thereof, and a lower holder adapted to support a torsion spring together with the upper holder, thereby enabling the outer fixing plate to be rotated.
